(19) United States
(12) Patent Application Publication
(10) Pub. No.: US 2013/0021257 A1
(43) Pub. Date: Jan. 24, 2013

(54) KEYBOARD FOR DYNAMIC DISPLAY AND A SYSTEM COMPRISING THE KEYBOARD

(71) Applicants: Finn Pedersen, Roskilde (DK); Jesper Glückstad, Frederiksberg (DK)

(72) Inventors: Finn Pedersen, Roskilde (DK); Jesper Glückstad, Frederiksberg (DK)

(73) Assignee: DANMARKS TEKNISKE UNIVERSITET, Kgs. Lyngby (DK)

(21) Appl. No.: 13/638,828

(22) PCT Filed: Mar. 31, 2011
(86) PCT No.: PCT/EP11/55069

§ 371 Date: Oct. 1, 2012

Related U.S. Application Data
(60) Provisional application No. 61/341,444, filed on Mar. 31, 2010.

(30) Foreign Application Priority Data
Mar. 31, 2010 (EP) 10158765.7
Mar. 31, 2010 (EP) 10158768.1

(51) Int. Cl. G06F 3/02

(52) U.S. Cl. 345/168

(57) ABSTRACT

The invention relates to a dynamic display keyboard comprising a plurality of key elements, each key element comprises a transmitting part capable of transmitting at least a part of light incident on the transmitting part; an elastic mat comprising a plurality of elevated elements capable of providing a tactile feedback and providing passage of light through the elevated elements; wherein each key element is fixedly connected to at least one respective elevated element; wherein an elevated element provides the tactile feedback in response to a user action directed against a respective key element fixedly connected to the respective elevated element; wherein the light provided to a transmitting part defines a visual value of the corresponding key element; and wherein the elastic mat is positioned between the display and the plurality of key elements.

In this way, the dynamic display keyboard is able to provide a tactile feedback in response to a user action directed towards a key of the keyboard.

The invention relates to a keyboard for dynamic display, e.g. a dynamic display keyboard. The invention further relates to a corresponding system.

There is today a large demand on dynamic display keyboards in which the symbols of the keyboard may be dynamically changed such as for example one day to provide a set of Cyrillic characters and the next day a set of Chinese characters.

A problem of the existing dynamic display keyboards is, among other things, their lack of resemblance with traditional keyboards with respect to e.g. size, weight and tactile behaviour of the keys.

It is an object of the present invention to, among other things, solve the abovementioned problem. The abovementioned problem is solved by a dynamic display keyboard comprising a plurality of key elements and a mat. Each key element comprises a transmitting part for transmitting at least a part of light incident on the transmitting part. The mat comprises a plurality of elevated elements for providing tactile feedback and for providing passage of light through the elevated elements. Each key element may be fixedly connected to at least one respective elevated element. The keyboard may be configured to be positioned in front of and possibly furthermore abutting at least a part of at least one display unit. Thus, the at least one display unit may provide light to the plurality of transmitting parts e.g. via the respective elevated elements. Thus, the light from the at least one display unit, which light may propagate through the transmitting parts, may define visual values of the corresponding key elements.

Thereby is achieved that the keyboard is dynamic and further is able to provide a tactile feedback in response to a user action directed towards a key of the keyboard. Further, the only power requiring element in the keyboard may be the display unit.

Other embodiments and advantages are provided below in the detailed description, in the claims and in the drawings.

### BRIEF DESCRIPTION OF THE DRAWINGS

FIG. 1a illustrates an embodiment of a dynamic display keyboard.

FIG. 1b illustrates an embodiment of a circular cross-sectional form along the X-X axis of a dome element.

FIG. 1c illustrates an embodiment of a square cross-sectional form along the X-X axis of a dome element.

FIG. 2 illustrates an embodiment of a dynamic display keyboard comprising a conducting fixator.

FIG. 3 illustrates an embodiment in which a key element 101 of the dynamic display keyboard comprising electrically conducting fixators is in a depressed state.

FIG. 4 illustrates an embodiment of the dynamic display keyboard further comprising a layer in which the key elements are included.

FIG. 5 illustrates an embodiment in which a key element of the dynamic display keyboard comprising a layer is in a depressed state.

FIG. 6 illustrates an embodiment of a key element.

FIG. 7 illustrates an embodiment of a device comprising a dynamic display keyboard comprising a detachable part and a light generating layer.

FIG. 8 illustrates an embodiment of a dynamic display keyboard providing an increased angle of view of the key elements.

### DETAILED DESCRIPTION OF THE INVENTION

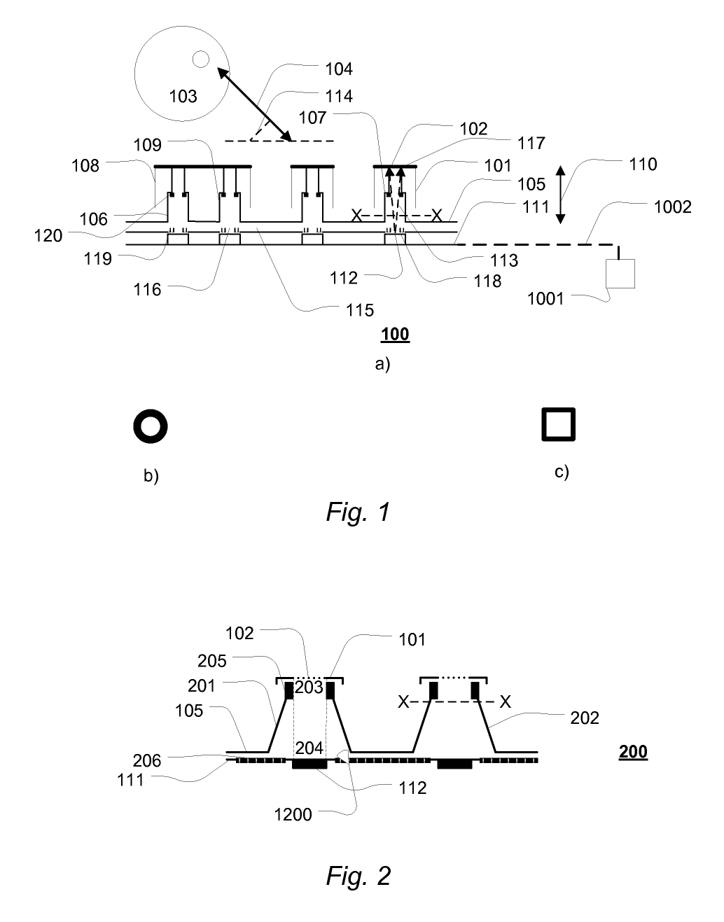

FIG. 1a illustrates an embodiment of a dynamic display keyboard 100. The dynamic display keyboard comprises a plurality of key elements 101 e.g. a plurality of alpha-numeric keys. Each of the key elements 101 comprises a transmitting part 102 capable of transmitting at least a part of light incident on the transmitting part 102.

In an embodiment, the transmitting part 102 may be made of or may comprise a transparent polymer or of silica glass or the like i.e. a material having a high transmittance of the incident light. In an additional embodiment, the transmitting part 102 is made of or comprises a material having a high transmittance of incident light visible to a human being i.e. in the wavelength range from approximately 380 nm (violet light) to 750 nm (red light).

The transmitting parts 102 may be positioned at the top of the key elements 101 as indicated in FIG. 1a. Thereby, light incident on the transmitting part 102 from a light generating device, such as a group of pixels 112 in a light generating device 111 (such as a flat-panel display e.g. OLED or LCD), may reach a user 103 e.g. via light path 104. The transmitting parts 102 may be fastened to the key element 101 via glue, vulcanization, or the like.

In general, for all embodiments of the present invention, fastening by means of glue and/or vulcanization and/or welding may provide a close-fitting or hermetic seal between parts, which seal may be at least substantially waterproof and/or dust-proof.

The dynamic display keyboard 100 may further comprise a mat 105 made of or comprising an elastic and flexible material such as rubber. The rubber mat 105 may comprise a plurality of elevated elements such as dome elements 106, 107, 109 capable of providing a tactile feedback. The dome elements 106, 107, 109 may be made in the same material as the mat 105. The mat 105 comprising the dome elements 106, 107, 109 may in one embodiment be cast in one piece. The dome elements 106, 107, 109 are open in both ends 117, 118 and hollow such as to enable passage of light from at least a group of pixels 112 of the light generating device 111 to the transmitting part 102.

The dome elements 106, 107, 109 may be hollow in order to reduce absorption of light in them. Alternatively, the dome elements 106, 107, 109 may be filled with a transparent and elastic and flexible material such as a transparent polymer or the like. The dome elements 106, 107, 109 may further be open in both ends 117, 118. Thereby, the dome elements 106, 107, 109 enable passage of light from at least a group of pixels 112 from the light generating device 111 to the transmitting part 102.

In an embodiment, the inner surface of the dome elements 106, 107, 109 may be coated with a reflecting material such as e.g. a thin metal layer such as aluminium.

Each key element 101 is fixedly connected to at least one dome element 106. As seen in FIG. 1a, key element 101 is fixedly connected to one dome element 107, and key element 108 is fixedly connected to two dome element 106 and 109. The number of dome elements 106, 107, 109 fixedly connected to a key element 101, 108 may depend on the size of the key element such that a large key (e.g. a space key) may be connected to a plurality of dome elements and a small key (e.g. a character key) may be connected to a single dome element.

In a computer keyboard, for example, a SHIFT key may be fixedly connected to two dome elements, an alpha-numeric key may be fixedly connected to one dome element, and the spacebar may be fixedly connected to four dome elements.

The term fixedly connected is to be understood as the key element may be resting on the dome element and/or it may be glued or vulcanized to the dome element and/or welded to the dome element.

In an embodiment, the dome elements 106, 107, 109 provides control of the dimensions in which the key elements 101, 108 may move in. The dome elements 106, 107, 109 may in an embodiment restrict the direction in which the key elements 101, 108 may move. In an embodiment, the direction to which the key elements may move may be the direction 110 perpendicular to the rubber mat 105 or substantially perpendicular to the rubber mat 105 e.g. 90 degrees+/−5 degrees.

In order to have the dome element deform, an external force provided by a user pressing the associated key element, is required. The dome elements may be made of or may comprise a soft plastic or rubber or any other material capable of deforming along the direction of movement 110 when an external force having a component in the direction of movement 110 is applied to the key element 101. In an embodiment, the dome element 106 may be such as to require a threshold force in the direction of movement 110 before deforming thereby providing a tactile response to a user applying a force to the key element 101 and making the dome element able to sustain the weight of the key element 101 without any substantial deformation in the direction of movement 110 of the key element when an external force is not applied.

Thereby, the dome element 106, 107, 109 is able to provide a tactile feedback in response to a user action e.g. a user pressing the key element.

The key element 101 may be made of or may comprise a material harder than the dome element. For example, the key element 101 may be made of or may comprise melamine resin.

FIG. 1b illustrates a circular cross-sectional view along the X-X axis of a dome element 106, 107, 109. The dome element 106, 107, 109 may be open in both ends i.e. the end 117 facing the key element 101, 109 and the end 118 facing the rubber mat 105.

The dynamic display keyboard 100 may further comprise at least one display unit 111. The display unit 111 is adapted to provide light to the plurality of transmitting parts 102. The display unit 111 may comprise an LCD or OLED in which a pixel or a group of pixels of the display are assigned to a key element 101. As seen in FIG. 1a, a group of pixels are positioned under the key element 101 comprising the transmitting part 102, and therefore light 113 emitted by the group of pixels 112 may pass the dome element 107 to reach the transmitting part 102. The group of pixels may comprise one or more pixels in one or two directions i.e. a linear or planar arrangement of pixels may be comprised in the group of pixels 112.

As seen in FIG. 1a, the elastic and flexible mat is positioned between the display unit 111 and the plurality of key elements 101, 108.

In an embodiment, the maximal height from the top of a transmitting part 102 of a key element 101 to the top of the group of pixels 112 associated with the key element 101 is approximately 3 mm i.e. 3 mm+/−0.1 mm. Thereby it is achieved that an approximately 45 pixel by 45 pixel image provided by a group of pixels 112 may be displayed via the transmitting part 102 and this image may be seen from an angle of view 114 of a user 103 in the range of 45° to 135°.

In an embodiment, the dynamic display keyboard 100 may additionally comprise a printed circuit board (PCB) 115 comprising a plurality of pads 119 for determining whether a key element 101, 108 has been pressed. Light passages 116, such as holes, are included in the printed circuit board 115. The light passages 116 are positioned under the dome elements 106, 107, 109. The PCB is positioned between the display unit 111 and the elastic and flexible mat 105.

Each pad 119 comprises a first and a second pad part, and the first pad part is electrically isolated from the second pad part. When a key element 101 is depressed, a conductive element 120 is brought into contact with the first and second pad parts thereby short circuiting the first and second pad parts of at least one pad 119, thereby enabling detection of the depressed key element 101.

In an embodiment, a processing unit 1001 may be communicatively coupled to the light generating layer 111 via a wireless and/or wired communication link such as Bluetooth or cable. The processing unit 1001 may determine which characters are to be displayed on which key elements 101 by providing a control signal to the respective group of pixels 112 under the key elements 102. In an embodiment, the processing device 1001 further comprises a power providing unit such as a connection to a power grid and/or an battery.

In an embodiment, any of the below embodiments of FIGS. 2 and 4 and 5 and 6 and 7 and 8 may be communicatively coupled to a processing device 1001 as disclosed above.

In an embodiment, the PCB circuit is communicatively coupled to the processing unit 1001 via a wireless and/or wired communication link such as Bluetooth or cable. The value of a detected depressed key element 101 may be transmitted from the PCB circuit to the processing unit 1001 for further processing.

FIG. 2 illustrates an embodiment 200 of a dynamic display keyboard. As in the above embodiment 100, the dynamic display keyboard 200 comprises a key element 101 comprising a transparent part 102. The transparent part 102 may be connected to the key element 101 by gluing, vulcanization, welding or the like.

Further, as described above, the dynamic display keyboard 200 further comprises a mat 105 made of or comprising an elastic and flexible material such as rubber. The rubber mat 105 may comprise a plurality of elevated elements such as dome elements 201, 202 capable of providing a tactile feedback as described above.

The dome elements 201, 202 of FIG. 2 may comprise a cross-sectional form being trapezium shaped in the plane illustrated in FIG. 2. Further, the cross sectional form of the dome elements 201, 202 may be square-shaped along the X-X plane. As above, the rubber mat 105 are open in both ends 203, 204 such as to enable light to pass the dome element from a light generating device 111 to the transparent part 102.

In this embodiment, the dynamic display keyboard 200 may comprise a light generating device 111 in the form of a touch sensitive display utilizing capacitive detection. An electrically insulating layer 206 such as a plastic or rubber may be deposited on the light generating layer with openings corresponding to the groups of pixels 112 defining the values of the key elements 101. The electrically insulating layer may thus be positioned between the light generating device 111 and the mat 105.

In an embodiment, the electrically insulating layer 206 may be transparent.

In an embodiment, the electrically insulating layer 206 may be comprised in the mat 105 such that the mat 105 constitutes both the isolating layer and the layer comprising the dome element.

In this embodiment, the rubber mat 105 further comprises fixators 205 to which the key elements 101 may be fixated e.g. by gluing, vulcanization, welding or the like. The distance between to opposing inner sides of the fixators 205 may correspond to size of the transparent part 102 in the respective dimensions of the plane containing the transparent part 102. The fixators 205 may be made of or may comprise a hard plastic or rubber material such as to provide a stable platform on which the key element 101 may be placed.

In an embodiment, the fixators 205 and the mat 105 and the key element 101 are able to conduct an electric current. For example, the hard plastic or rubber of the fixators may be doped with a metallic powder such as iron or the like. Alternatively or additionally, the fixators 205 may contain an electric wire providing an electrically closed loop. Additionally, the mat 105 comprising the dome elements 106, 107, 109 may be made of or may comprise an elastic plastic or rubber doped with a metallic powder such as iron Fe or the like. In an embodiment, the transmitting part 102 may also be made of or may comprise an electrical conducting material such as electrical conducting silica glass (e.g. silica glass doped with iron Fe or manganese Mn).

In an embodiment, the light generating device 111 is a touch sensitive display with capacitive detection.

In an embodiment, the fixators 205 are cast together with the dome elements 201 during production of the mat 105.

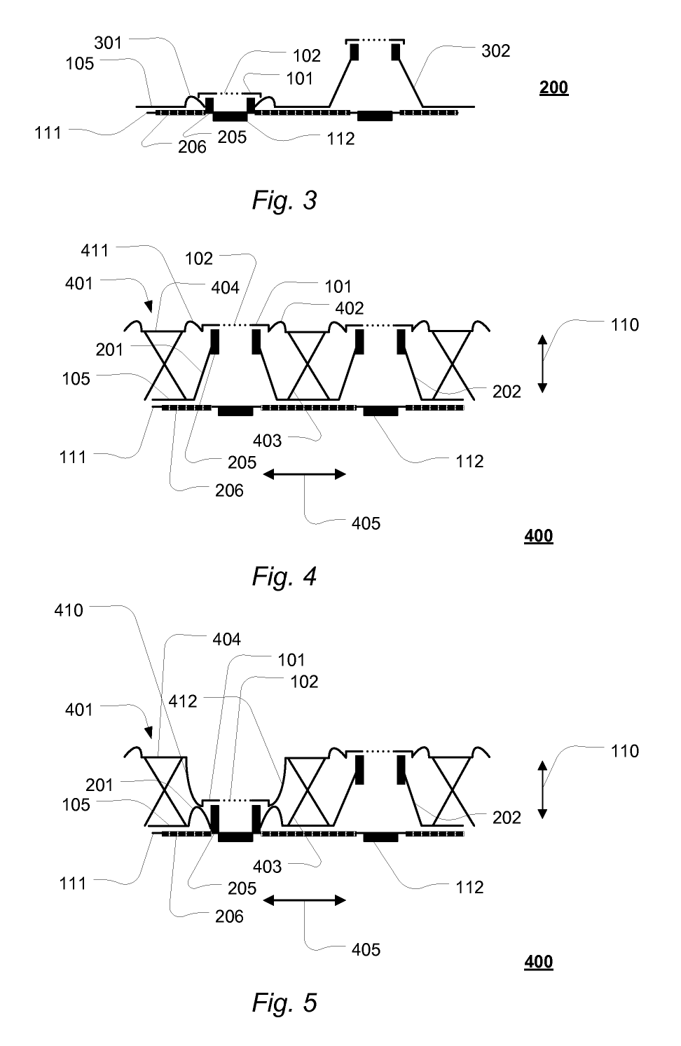

FIG. 3 illustrates an embodiment in which a key element 101 of the dynamic display keyboard 200 comprising electrically conducting fixators is in a depressed state. In this embodiment, the light generating device 111 is a touch sensitive display with capacitive detection. Thereby, when a key element 101 is depressed, the electrically conductive fixators 205 of the key element 101 is brought into contact with the electric field of the capacitive detection and thereby, the touch sensitive display may detect the depressed key element 101. Thereby, the dynamic display keyboard 200 may be used in combination with a touch sensitive display which may provide the value of the key elements 101 by displaying respective key values under respective key elements 101 and the touch display may further provide detection of a depressed key element 101 by detecting changes to the electric field provided by the capacitive detection. 301 and 302 denotes depressed/flexed dome elements 201, 202. The detected depressed key value may be transmitted to the processing unit 1001 for further processing.

In an alternative embodiment, the light generating device 111 may be a non-touch sensitive display and the dynamic display keyboard may, as in embodiment 100, comprise a PCB layer 115 and pads 119 and 120 for detection of a depressed key.

FIG. 4 illustrates an embodiment 400 of the dynamic display keyboard 200 further comprising a layer 401 (also denoted a top layer) in which the key elements 101 are included. The layer 401 may provide a close-fitting or hermetic sealing, which may be at least substantially waterproof and/or dust-proof.

The layer 401 may comprise a collar/ridge 402. The collar/ridge 402 is made of or comprises an elastic and flexible material such as rubber. Additionally, the layer 401 may comprise a rigid part 404 made of or comprising a hard and non-flexible plastic.

Between the rigid part 404 and the mat 105 (in the direction 110), supporting elements 403 may be positioned i.e. between the dome elements 201 of the mat 105 (in the direction 406). The supporting elements 403 support the layer 401. The supporting elements 403 may be glued or vulcanized or welded to the rigid part 404 and the mat 105.

The key elements 101 comprises a transparent part 102 i.e. a transparent window. The key elements 101 may be glued or vulcanized or welded to the collar/ridge 402.

In an embodiment, the collar/ridge 402 is made of or comprises a transparent elastic and flexible material.

In an embodiment, the dynamic display keyboard 400 further comprises an electrically insulating layer 206 such as a plastic or rubber deposited on the light generating layer 111 with openings corresponding to the groups of pixels 112 defining the values of the key elements 101.

In an embodiment, the light generating layer 111 of the dynamic display keyboard 400 is a touch sensitive display with capacitive detection.

In an alternative embodiment, the dynamic display keyboard 400 comprises a PCB circuit on top of the light generating layer 111 as illustrated in FIG. 1.

In an embodiment, the height from the top of the light generating layer 111 and to the top of the transparent window 102 is chosen in the range from 2.5 mm to 3.5 mm.

In an embodiment, the height from the top of the light generating layer 111 and to the top of the transparent window 102 is chosen in the range from 2 mm to 3 mm. In an embodiment, the height from the top of the light generating layer 111 and to the top of the transparent window 102 is chosen to be 3 mm. Thereby, a large angle of view of the key values associated with a key element for a user is provided by the dynamic display keyboard.

FIG. 5 illustrates an embodiment in which a key element 101 of the dynamic display keyboard 400 is in a depressed state. In the depressed state, the dome element 201 of the depressed key element 101 and the collar/ridge 402 of the depressed key 101 are flexing to provide the tactile feedback of the key element 101.

In an embodiment, the light generating device 111 is a touch sensitive display with capacitive detection. Thereby, when a key element 101 is depressed, the electrically conductive fixators 205 of the key element 101 is brought into contact with the electric field of the capacitive detection and thereby, the touch sensitive display may detect the depressed key element 101. Thereby, the dynamic display keyboard 400 may be used in combination with a touch sensitive display which may provide the value of the key elements 101 by displaying respective key values under respective key elements 101 and the touch display may further provide detection of a depressed key element 101 by detecting changes to the electric field provided by the capacitive detection. 301 and 302 denotes depressed/flexed dome elements 201, 202 and 410 and 412 denotes depressed/flexed collar/ridge elements 402 and 411.

In an alternative embodiment, the light generating device 111 may be a non-touch sensitive display and the dynamic display keyboard 400 may, as in embodiment 100, comprise a PCB layer 115 and pads 119 and 120 for detection of a depressed key.

This embodiment (i.e. the embodiment of FIGS. 4 and 5), among other things, provides a keyboard with a layer 401 that is easily cleaned and which prevents dust and other things or fluids from falling in between the dome elements 201.

FIG. 7 illustrates an embodiment 700 of a device comprising a dynamic display keyboard 701 according to any of embodiments 1, 2, and 4, i.e. comprising a detachable part 602 and a light generating layer 111. Additionally, the device further comprises a second light generating layer 702 such as a LCD flatpanel or the like.

The device 700 may comprise a sliding mechanism such that the device may be in a closed state as indicated in FIG. 7 (a), a state 7 (b) in which the dynamic display keyboard 701 comprising the detachable part 602 and the light generating layer 111 are slid out such that the dynamic display keyboard may be used, and a state 7 (c) in which only the second light generating layer 702 is slid out in order to provide a larger total light generating device area.

In an embodiment, the detachable part 602 and the light generating layer 111 may be hinged together in order to enable the sliding according to FIG. 7 (b). FIG. 7 (c) may be achieved by opening the hinges hinging the detachable part 602 and the light generating layer 111 together.

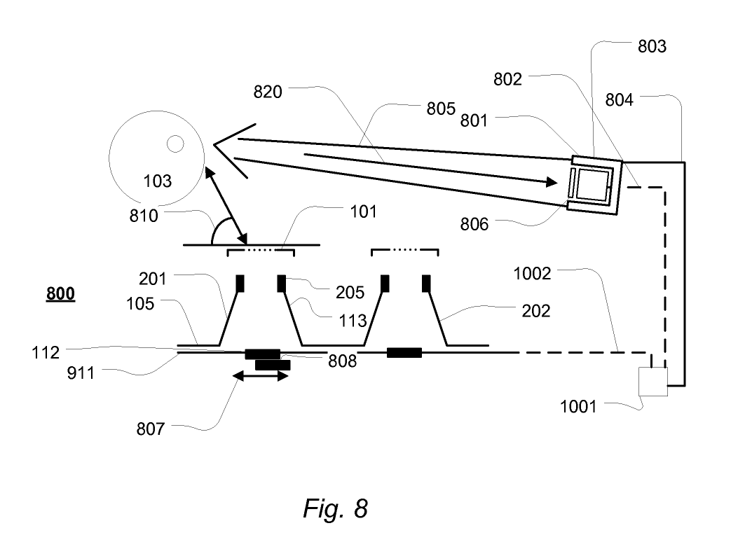

FIG. 8 illustrates an embodiment of a dynamic display keyboard 800 providing an increased angle of view of the key elements 101.

The dynamic display keyboard may be as illustrated in FIG. 1 or 2 or 4. Additionally, the dynamic display keyboard 800 may comprise a detector 801. The detector 801 may be a camera recording images of the user 103 and more specific of the user's head and/or face. Thus, the detector 801 may be a tracker tracking the head of the user 103.

The images from the detector 801 may be transmitted to the processing unit 1001 via a wireless and/or wired communication link such as a Bluetooth link 802 or a cable 804.

The processing unit 1001 may calculate the user's head's distance and angle with respect to the dynamic display keyboard 800 based on the received images from the detector 801.

In an embodiment, the processing unit 1001 may utilize edge detection in order to determine the head/face of the user from the images received.

In an alternative embodiment, the dynamic display keyboard 800 may further comprise an IR transmitter 803 communicatively coupled to the processing unit 1001 via a wireless 802 and/or wired 804 communication link such as a Bluetooth link or a cable. The IR transmitter may illuminate the head/face of the user 103 with IR light 805. An optical filter 806 may be placed in front of the detector 801 such as a bandpass filter. The optical filter may restrict the bandwidth of the light 820 reaching the detector to e.g. IR light. Thereby, high contrast may be achieved in the images recorded by the detector. The images may be transmitted to the processing unit.

Based on the calculated angle and distance of the user's head/face with respect to the dynamic display keyboard 800, the processing unit 1001 may determine that the group of pixels 112 providing the values of respective key elements 101 may be changed to another group of pixels 808. The other group of pixels 808 may for example correspond to the group of pixels 112 translated in the plane 807 of the light generating layer 111 such as to compensate for the angle and/or distance of the user's head/face. Thereby, the angle of view may be increased with respect to the user 103.

In an embodiment, the angle of view may be changed manually by a user by activating a button connected to the processing device and e.g. comprising a number of steps. For example, one step corresponding to an angle of view between 90 degrees and 60 degrees and another step corresponding to an angle of view between 60 and 30 degrees.

In one aspect, the above described dynamic display keyboard may be used to e.g. provide different values to a key in a keyboard. One day, the keyboard may provide Latin alphabet key values and the next day Cyrillic alphabet key values. Alternatively or additionally, the dynamic display keyboard may ease use of special keys such as Alt Gr, CTRL, etc. When pressing one of these special keys, the dynamic display keyboard may only illuminate the keys and key values that can be reached in combination with the special key pressed down.

In an embodiment, the keyboard may be included in a computer system via a wired and/or wireless communication link such as an electric cable and/or a Bluetooth link. In this embodiment, the keyboard may comprise a short-range radio receiver and transmitter (e.g. a Bluetooth transmitter and receiver) and the computer system may comprise a similar short-range radio receiver and transmitter. Additionally or alternatively, the keyboard and the computer system may comprise a socket for an electric wire via which the computer system and the keyboard may be connected via an electric wire.

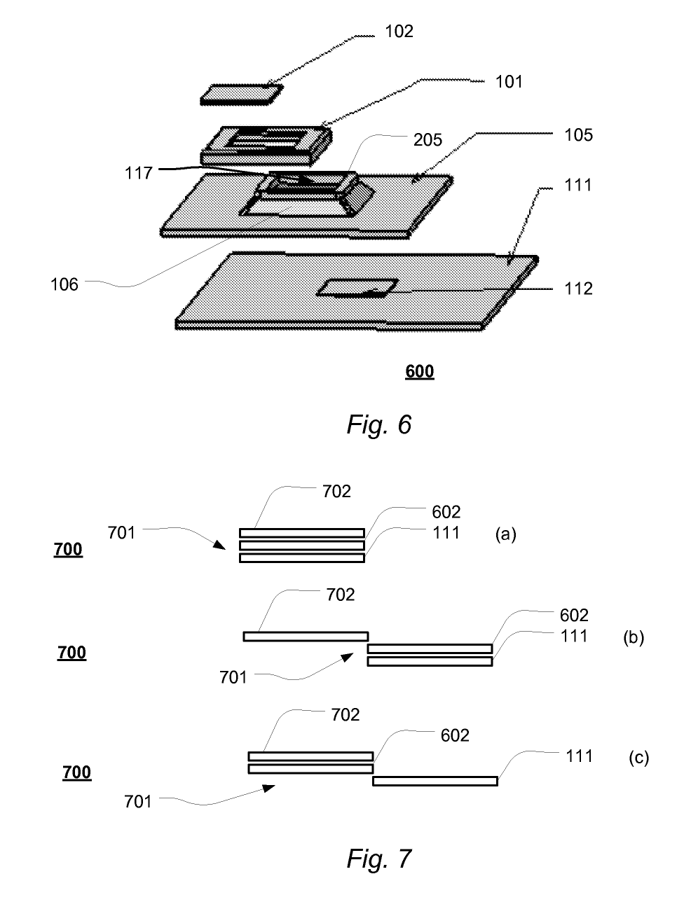

FIG. 6 illustrates an embodiment of a key 600 for use in a keyboard as described above under FIGS. 1 to 5 and FIG. 8. The key element 101 comprises a transmitting part 102 capable of transmitting at least a part of light incident on the transmitting part 102.

In an embodiment, the transmitting part 102 may be made of or may comprise a transparent polymer or of silica glass or the like i.e. a material having a high transmittance of the incident light. In an additional embodiment, the transmitting part 102 is made of or comprises a material having a high transmittance of incident light visible to a human being i.e. in the wavelength range from approximately 380 nm (violet light) to 750 nm (red light).

The transmitting parts 102 may be positioned at the top of the key element 101 or included in the key element 101.

The key element 101 may be fixedly connected to an elevated element 106 contained in a mat 105 made of or comprising an elastic and flexible material such as rubber. The dome element 106 provides a tactile feedback. The dome element 106 may be made in the same material as the mat 105. The mat 105 comprising the dome element 106 may in one embodiment be cast in one piece. The dome element 106 may be open in both ends 117 (only one open end is visible in FIG. 6) and hollow such as to enable passage of light e.g. from a group of pixies 112 contained in a display unit 111.

Thus, the dome element 106 may be hollow in order to reduce absorption of light in them. The dome element 106 may further be open in both ends 117. Thereby, the dome element 106 enables passage of light to the transmitting part 102.

In an embodiment, the inner surface of the dome element 106, 107, 109 may be coated with a reflecting material such as e.g. a thin metal layer such as aluminium.

The number of dome elements 106 fixedly connected to a key element 101 may depend on the size of the key element such that a large key (e.g. a space key) may be connected to a plurality of dome elements and a small key (e.g. a character key) may be connected to a single dome element.

In an embodiment, the dome element 106 provides control of the dimensions in which the key elements 101 may move in. The dome element 106 may in an embodiment restrict the direction in which the key element 101 may move. In an embodiment, the direction to which the key element may move may be the direction perpendicular to the rubber mat 105 or substantially perpendicular to the rubber mat 105 e.g. 90 degrees+/−5 degrees.

In order to have the dome element 106 deform, an external force provided by a user pressing the associated key element 101, is required. The dome element 106 may be made of or may comprise a soft plastic or rubber or any other material capable of deforming along the direction of movement when an external force having a component in the direction of movement is applied to the key element 101. In an embodiment, the dome element 106 may be such as to require a threshold force in the direction of movement 110 before deforming thereby providing a tactile response to a user applying a force to the key element 101 and making the dome element able to sustain the weight of the key element 101 without any substantial deformation in the direction of movement of the key element when an external force is not applied.

Thereby, the dome element 106 is able to provide a tactile feedback in response to a user action e.g. a user pressing the key element.

The key element 101 may be made of or may comprise a material harder than the dome element. For example, the key element 101 may be made of or may comprise melamine resin.

In an embodiment, the maximal height from the top of a transmitting part 102 of a key element 101 to the bottom of the mat 105 is approximately 3 mm i.e. 3 mm+/−0.1 mm. Thereby it is achieved an angle of view of a user in the range of 45° to 135° of the key element 101.

In an embodiment, the key element further comprises a fixator 205 to which the key elements 101 may be fixedly connected e.g. by gluing, vulcanization, welding or the like. The fixator 205 is cast during production of the mat 105. The fixator 205 and the mat 105 comprising the dome elements 106 may be made in an electrical conductive material such as rubber doped with iron Fe. In an embodiment, the fixator 205 may be made of or may comprise a hard plastic or rubber material such as to provide a stable platform on which the key element 101 may be placed.

In an embodiment, a keyboard comprises a plurality of the key elements 101 described above.

An effect of such a keyboard is that it enables persons with long fingernails to use a touch sensitive display unit. Prior to the present invention, persons with long fingernails could attempt to use the nails in order to press a key on the touch sensitive display unit. However, since a nail is none-conducting, the attempt to press the key would not be registered via the capacitive detection. Applying a keyboard as disclosed above, the person with long fingernails will use the finger to press the key element, and the nail may be positioned in an air-gap between the key elements. The finger is conductive and thus, the capacitive detection will detect the pressed key element.

In an embodiment, the dynamic display keyboard of FIG. 1 a) or 2 or 4 or 8 may further comprise a photo-detector 1200 (see FIG. 2) in proximity to each group of pixels associated with a respective key element 101. The photo-detector may be communicatively coupled via Bluetooth or a wire to the processing unit 1001. The photo-detector may detect the intensity of light reaching the photo-detector 1200. When a key-element is depressed, the intensity of light detected by the photo-detector decreases due to 1) the object (e.g. a finger) placed on the key element 101 and thus also the transmitting part 102 by the user and 2) the depressed key element may further block for light reaching the photo-detector 1200. Thus, the intensity of light detected by the photo-detector may be used to determine when a key element is depressed. For example, the processing unit may receive intensity-measurements from the photo-detectors each millisecond, and if one or more of the intensities from the respective photo-detectors falls below a predetermined threshold value, then the processing unit 1001 may determine that the one or more key elements 101 associated with the photo-detectors measuring a decrease in intensity, have been depressed.

For any embodiment according to the present invention, the plurality of key elements may include at least 27 key elements, such as at least 40 key elements. Each key element may have a surface area of at least 1 cm² and/or a substantially squared surface area measuring at least 1 cm in one direction and 0.5 cm in another direction.

The mat and the plurality of key elements may be configured for conducting an electric current, such that the capacitance of a finger (i.e. caused by a finger, in particular by a tip of a finger) depressing a respective key element may be sensed by e.g. a capacitive detection means of the at least one display unit. Thus, improved use of the present keyboard in connection with a touch sensitive display is provided.

The mat may comprises a material doped with a metallic powder such as iron. Alternatively or in combination, the mat may comprise an electric wire.

Each key element may comprise an electrical conducting silica glass such as silica glass doped with iron or manganese.

The keyboard may be configured to be detachably attached to the at least one display unit e.g. by means of connection means such as at least one magnetic connection element such as at least one magnetic snap-connection element. Thus a simple attachment may be provided.

A magnetic snap-connection may be a connection means utilizing at least one magnet and at least one second part, which second part comprises a magnet and/or a magnetic material.

The keyboard may be configured to be movably attached to the at least one display unit e.g. by means of a hinge means.

The keyboard may be configured to be positioned in front of the at least a part of the at least one display unit such that the mat is positioned between the at least one display unit and the plurality of key elements.

A keyboard system may comprise a keyboard according to the present invention and may comprise the at least one display unit.

The processor may be communicatively coupled to the at least one display via a wired and/or wireless communication link.

A method for providing a dynamic display keyboard may be provided. The method may comprise placing a keyboard according to the present invention on (i.e. e.g. in front of and/or on top of) the at least one display unit.

For the method, the keyboard may be detachably connected to the at least one display unit by means of connection means such as at least one magnetic connection such as at least one magnetic snap-connection.

Although some embodiments have been described and illustrated in detail, the invention is not restricted to them, but may also be embodied in other ways within the scope of the subject matter defined in the following claims. In particular, it is to be understood that other embodiments may be utilised and structural and functional modifications may be made without departing from the scope of the present invention.

In device claims enumerating several means, several of these means can be embodied by one and the same item of hardware. The mere fact that certain measures are recited in mutually different dependent claims or described in different embodiments does not indicate that a combination of these measures cannot be used to advantage.

It should be emphasized that the term “comprises/comprising” when used in this specification is taken to specify the presence of stated features, integers, steps or components but does not preclude the presence or addition of one or more other features, integers, steps, components or groups thereof.

Items

A dynamic display keyboard comprising

a plurality of key elements 101, each key element 101 comprises a transmitting part 102 capable of transmitting at least a part of light incident on the transmitting part;

an mat 105 comprising a plurality of elevated elements 106, 107, 109, 201, 202 capable of providing a tactile feedback and providing passage of light through the elevated elements;

wherein each key element 101 is fixedly connected to at least one respective elevated element 106, 107, 109, 201, 202;

at least one display unit 111 capable of providing light to the plurality of transmitting parts 102 via the respective elevated elements 106, 107, 109, 201, 202; and wherein the light propagating through a transmitting part 102 defines a visual value of the corresponding key element 101; and

wherein the elastic mat 105 is positioned between the at least one display unit 111 and the plurality of key elements 101.

A dynamic display keyboard according to item 1, wherein a part 205 of the elevated element 106, 107, 109, 201, 202 physically contacting the key element 101 is electrically conducting.

A dynamic display keyboard according to item 2, wherein the dynamic display keyboard further comprises an electrically insulating layer 206 positioned on the at least one display unit 111 and comprising openings corresponding to the passages of light in the mat 105.

A dynamic display keyboard according to item 3, wherein the electrically insulating layer 206 is contained in the mat 105.

A dynamic display keyboard according to any of the preceding items, wherein the dynamic display keyboard further comprises a layer 401 comprising a collar 402 for each key element and wherein each key element 101 comprising a transmitting part 102 is fixedly connected to a respective collar 402.

A dynamic display keyboard according to item 5, wherein the dynamic display keyboard further comprises at least one supporting element 403 positioned between the layer 401 and the mat 105.

A dynamic display keyboard according to any of the preceding items, wherein the height from the top of the at least one display unit to the top of the transmitting part 102 is selected in the range from 2.0 mm to 3.0 mm.

A dynamic display keyboard according to any of the preceding items wherein the mat and the plurality of key elements 101 constitutes a flexible unit which may be rolled onto a display unit 111.

A dynamic display keyboard according to any of the preceding items, wherein the transmitting part is transparent.

A dynamic display keyboard according to any of the preceding items, wherein the keyboard further comprises a detector adapted to record an image of a user's face and a processor adapted to calculate an angle between a user's face and the dynamic display keyboard and a distance between the user's face and the dynamic display keyboard.

A dynamic display keyboard according to item 10, wherein the detector comprises a camera and wherein the processor is adapted to perform edge detection on images received from the camera in order to calculate the angle and/or distance.

A dynamic display keyboard according to item 10, wherein the detector comprises a camera with an infrared passband filter and infrared source illuminating the user, and wherein the processor is adapted to calculate the angle and/or distance from the images received from the camera.

A dynamic display keyboard according to any of items 10-12, wherein the processor is further adapted to change a part of the at least one display unit 111 illuminating a corresponding key element 101 based on the angle and/or distance.

A system comprising a dynamic display keyboard according to any of items 1 to 13, wherein the system is communicatively coupled to the dynamic display keyboard via a wired and/or wireless communication link.

A key for use in a keyboard comprising

a key element 101 comprising a transmitting part 102 capable of transmitting at least a part of light incident on the transmitting part;

an elevated element 106, 107, 109, 201, 202 adapted to provide a tactile feedback when the key is depressed;

wherein the key element 101 is fixedly connected to a first end 117 of the elevated element 106, 107, 109;

wherein the elevated element comprises an opening 113 in the first end 117 and an opening 118 opposite to the first end such that light may be transmitted through the elevated element towards the key element 101.

1. A keyboard unit for use with a dynamic display, comprising:
a plurality of key elements, each key element including a transmitting part for transmitting at least a part of light incident on the transmitting part; and
a mat including a plurality of elevated elements, each key element corresponding to at least one respective elevated element, the key elements and the elevated elements providing tactile feedback, wherein,
when the mat overlaps a portion of a display unit configured to display the dynamic display, an image displayed on the portion of the display unit is transmitted through the transmitting parts to define visual values of corresponding key elements,
the mat is an elastic mat including an elastic and flexible material, and
the keyboard unit is configured to be rolled onto the display unit.

2. The keyboard unit according to claim 1, wherein capacitance of a finger depressing a respective key element may be sensed by the display unit.

3. The keyboard unit according to claim 27, wherein the mat comprises a material doped with a metallic powder.

4. The keyboard unit according to claim 27, wherein the mat comprises an electric wire.

5. The keyboard unit according to claim 27, wherein each key element comprises an electrically conducting silica glass.

6. The keyboard unit according to claim 1, wherein a part of each of the plurality of elevated elements physically contacting a respective key element is electrically conducting.

7. The keyboard unit according to claim 1, wherein an electrically insulating layer abuts the portion of the display unit when the keyboard unit is positioned in front of and abutting the portion of the display unit.

8. The keyboard unit according to claim 7, wherein the electrically insulating layer is contained in the mat.

9. The keyboard unit according to claim 1, wherein a top layer of the keyboard unit includes a collar for each key element.

10. The keyboard unit according to claim 9, further comprising at least one supporting element under the top layer.

11. The keyboard unit according to claim 1, wherein a height from a top of display unit to a top of the transmitting part of one of the plurality of key elements is selected in a range from 2.0 mm to 3.0 mm.

12. The keyboard unit according to claim 1, wherein the mat comprises rubber.

13. (canceled)

14. The keyboard unit according to claim 1, wherein the transmitting part is transparent.

15. The keyboard unit according to claim 1, wherein a securing mechanism detachably attaches the keyboard unit to the display unit.

16. The keyboard unit according to claim 1, wherein a securing mechanism movably attaches the keyboard unit to the display unit.

17.-26. (canceled)

27. The keyboard unit according to claim 2, wherein the mat and the plurality of key elements are configured to conduct an electric current.

28. The keyboard unit according to claim 1, wherein each elevated element is wider at a surface adjacent the mat than at a surface adjacent the respective key element.

29. The keyboard unit according to claim 1, wherein the elevated elements are formed of the elastic and flexible material.

30. The keyboard unit according to claim 1, wherein the elevated elements are hollow.

31. A keyboard system, comprising:
a display unit configured to display a dynamic display; and
a keyboard unit, the keyboard unit including:
a plurality of key elements, each key element including a transmitting part for transmitting at least a part of light incident on the transmitting part; and
a mat including a plurality of elevated elements, each key element corresponding to at least one respective elevated element, the key elements and elevated elements providing tactile feedback, wherein
when the keyboard unit overlaps a portion of the display unit, an image displayed on the portion of the display unit is transmitted through the transmitting parts defines visual values of corresponding key elements,
the mat includes an elastic and flexible material, and
the keyboard unit is an at least semi-flexible unit configured to be rolled onto the portion of the display unit.

32. The keyboard system according to claim 31, wherein the display unit is a touch sensitive display.
